(19) United States
(12) Patent Application Publication
(10) Pub. No.: US 2026/0264769 A1
(43) Pub. Date: Sep. 10, 2026

(54) HYBRID ISOLATING STRUCTURES OF MOTOR VEHICLE

(71) Applicant: GM GLOBAL TECHNOLOGY OPERATIONS LLC, DETROIT, MI (US)

(72) Inventors: Sam Mohamad Jomaa, Northville, MI (US); Michael Andrew Gutierrez, Dearborn Heights, MI (US); Frank D. Risko, Clarkston, MI (US); Mary Gilliam, Farmington Hills, MI (US); Michael J. Lukitsch, Marysville, MI (US); Steven Billingsley, Holland, MI (US)

(21) Appl. No.: 19/073,698

(22) Filed: Mar. 7, 2025

(51) Int. Cl. B62D 29/00; B29C 45/14

(52) U.S. Cl. CPC B62D 29/004; B29C 45/14786; B29C 2045/14885

(57) ABSTRACT

A structural member of a vehicle includes a metal substrate portion and an overmold portion of a glass fiber reinforced thermoplastic material joined to the metal substrate portion. The overmold portion is connected to and supportive of one or more actuated components of the vehicle. The metal substrate portion is subjected to one or more surface treatments to ensure bonding of the overmold portion to the metal substrate portion. A method of forming a structural member of a vehicle includes forming a metal substrate portion, and applying one or more surface treatments to an outer surface of the metal substrate portion. An overmold portion is applied over the metal substrate portion. The overmold portion is formed from a glass fiber reinforced plastic material. The overmold is configured to be connected to and support one or more actuated components of the vehicle.

The subject disclosure relates to vehicles, and in particular to vibration isolating structures of vehicles, for example, vehicle cross-members.

Structural vibration isolating members are utilized in motor vehicles to, for example, improve structural rigidity of the vehicle body and to support drive units and other propulsion system components of the vehicle, or other modules such as compressors or stand-alone integrated thermal modules having actuated devices attached to them. The members are typically formed from metal, with vibration-absorbing structures, such as bushings or the like, attached thereto. Complex shapes of such members, however, are difficult to form, with manufacturing processes for the metal members having many restrictions, or may require complex and expensive hydroforming processes to appropriately position the vibration-absorbing structures relative to the metal member. Additionally, the metal members may be relatively heavy and may exhibit negative performance characteristics related to vibration transmissibility.

### SUMMARY

In one exemplary embodiment, a structural member of a vehicle includes a metal substrate portion and an overmold portion of a glass fiber reinforced thermoplastic material joined to the metal substrate portion. The overmold portion is connected to and supportive of one or more actuated components of the vehicle. The metal substrate portion is subjected to one or more surface treatments to ensure bonding of the overmold portion to the metal substrate portion.

In addition to one or more of the features described herein, the overmold portion is configured to have a greater stiffness than the metal substrate portion.

In addition to one or more of the features described herein, the overmold portion is formed from one of a polyamide 66 or a polyamide 6 material.

In addition to one or more of the features described herein, the one or more surface treatments include one or more of a laser treatment and a plasma treatment of the metal substrate portion.

In addition to one or more of the features described herein, the one or more surface treatments define one or more of a plurality of troughs, or a hook-and-loop structure via laser treatment of an outer surface of the metal substrate portion into which the material of the overmold portion is flowed. The laser treatment includes one or more of laser cleaning or laser ablation by changing surface energy, microstructure, or surface chemistry to enhance chemical bonding between the overmold portion and the metal substrate portion.

In addition to one or more of the features described herein, one of a substrate surface energy is increased, or a thin film is created on the substrate surface via the plasma treatment to enhance chemical bonding between the overmold portion and the metal substrate portion.

In addition to one or more of the features described herein, the overmold portion includes one or more bushing openings extending therethrough outside of a perimeter of the metal substrate portion. The one or more bushing openings are receptive of an elastomeric bushing via which the one or more actuated components are secured to the structural member.

In another exemplary embodiment, a vehicle includes a vehicle structure, and a structural member extending at least partially across a width of the vehicle structure and secured to the vehicle structure. The structural member includes a metal substrate portion and an overmold portion of a glass fiber reinforced plastic material joined to the metal substrate portion. The overmold portion is connected to and supportive of one or more actuated devices of the vehicle. The metal substrate portion is subjected to one or more surface treatments to ensure bonding of the overmold portion to the metal substrate portion.

In addition to one or more of the features described herein, the overmold portion is configured to have a greater stiffness than the metal substrate portion.

In addition to one or more of the features described herein, the overmold portion is formed from one of a polyamide 66 or polyamide 6 material.

In addition to one or more of the features described herein, the one or more surface treatments include one or more of a laser treatment and a plasma treatment of the metal substrate portion.

In addition to one or more of the features described herein, the one or more surface treatments define one or more of a plurality of troughs, or a hook-and-loop structure via laser treatment of an outer surface of the metal substrate portion into which the material of the overmold portion is flowed. The laser treatment includes one or more of laser cleaning or laser ablation by changing surface energy, microstructure, or surface chemistry to enhance chemical bonding between the overmold portion and the metal substrate portion.

In addition to one or more of the features described herein, one of a substrate surface energy is increased, or a thin film is created on the substrate surface via the plasma treatment to enhance chemical bonding between the overmold portion and the metal substrate portion.

In addition to one or more of the features described herein, the overmold portion includes one or more bushing openings extending therethrough outside of a perimeter of the metal substrate portion. The one or more bushing openings are receptive of an elastomeric bushing via which the one or more actuated components are secured to the structural member.

In yet another exemplary embodiment, a method of forming a structural member of a vehicle includes forming a metal substrate portion, and applying one or more surface treatments to an outer surface of the metal substrate portion. An overmold portion is applied over the metal substrate portion. The overmold portion is formed from a glass fiber reinforced plastic material. The overmold is configured to be connected to and support one or more actuated components of the vehicle.

In addition to one or more of the features described herein, the one or more surface treatments include one or more of a laser treatment and a plasma treatment of the metal substrate portion.

In addition to one or more of the features described herein, the one or more surface treatments define one or more of a plurality of troughs, or a hook-and-loop structure via laser treatment of an outer surface of the metal substrate portion into which the material of the overmold portion is flowed. The laser treatment includes one or more of laser cleaning or laser ablation by changing surface energy, microstructure, or surface chemistry to enhance chemical bonding between the overmold portion and the metal substrate portion.

In addition to one or more of the features described herein, one of a substrate surface energy is increased, or a thin film is created on the substrate surface via the plasma treatment to enhance chemical bonding between the overmold portion and the metal substrate portion.

In addition to one or more of the features described herein, the overmold portion is configured to have a greater stiffness than the metal substrate portion.

In addition to one or more of the features described herein, the overmold portion is formed via injection molding.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a side view of an embodiment of a vehicle;

FIG. 2 is a plan view of an embodiment of a cross-member of a vehicle;

FIG. 3 is a cross-sectional view, taken along line 3-3 of FIG. 2, of an embodiment of a cross-member of a vehicle; and

FIG. 4. is a perspective view of an embodiment of a substrate of a cross-member.

### DETAILED DESCRIPTION

The following description is merely exemplary in nature and is not intended to limit the present disclosure, its application or uses. It should be understood that throughout the drawings, corresponding reference numerals indicate like or corresponding parts and features.

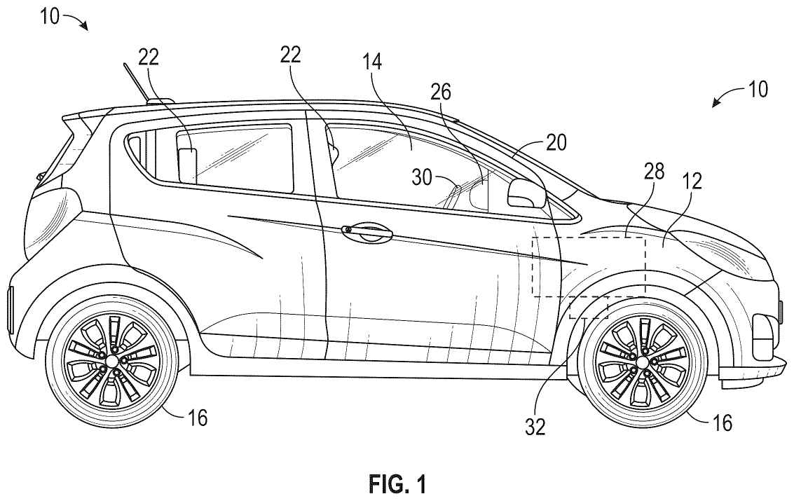

In accordance with an exemplary embodiment a vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. Body 12 defines, in part, an occupant compartment 14 having seats 22 positioned behind a dashboard 26. A steering control 30 is arranged between seats 22 and dashboard 26. Steering control 30 is operated to control orientation of the steerable wheel(s) 16. A powertrain 28 is operably connected to the plurality of wheels 16, and one or more components of the powertrain 28 are secured to and supported by one or more cross-members 32 installed to the body 12.

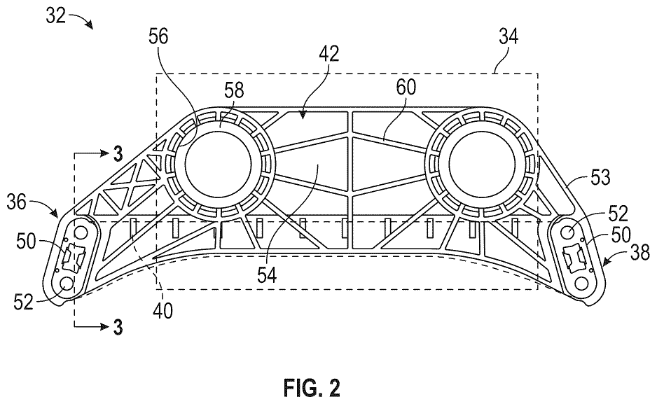

Illustrated in FIG. 2 is an exemplary embodiment of a cross-member 32 which is supportive of a powertrain component 34, such as a drive unit, of the vehicle 10. The cross-member 32 extends laterally at least partially across the vehicle 10 and is secured to the vehicle structure, for example, the body 12 at a first member end 36 and a second member end 38 of the cross-member 32. While the cross-member 32 illustrated is secured to the body 12 at both the first member end 36 and the second member end 38, in other embodiments the cross-member 32 may be secured to the vehicle structure at only one of the first member end 36 and the second member end 38.

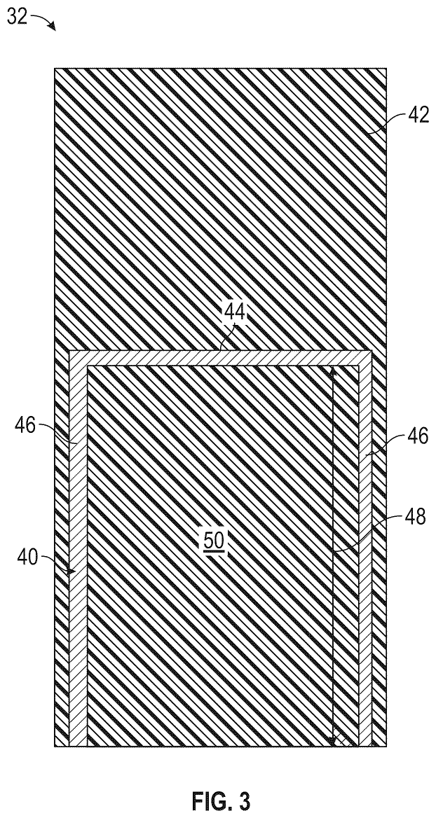

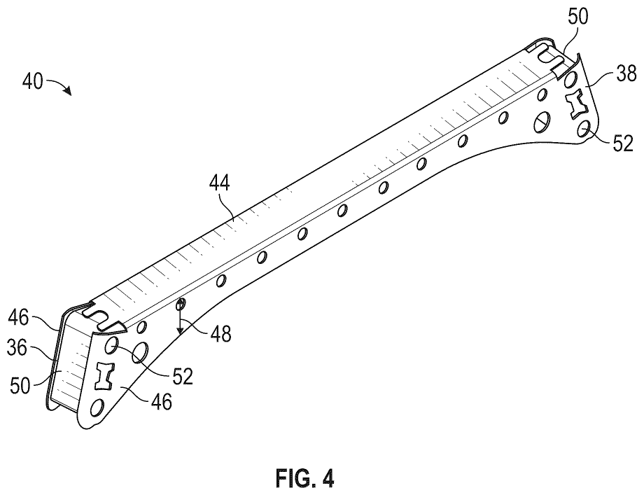

The cross-member 32 includes, as shown in the cross-sectional view of FIG. 3, a metal substrate 40 and a fiber reinforced thermoplastic overmold 42 at least partially surrounding and enclosing the metal substrate 40. Referring now to FIG. 4, an embodiment of the substrate 40 is illustrated in which the substrate 40 is formed from a metal plate, in some embodiments a steel or aluminum material, that is formed into a C-shaped cross-section. In the C-shaped cross-section, a flange length and a material thickness are selected to provide a desired dynamic stiffness to the substrate 40. In some embodiments, a ratio of dynamic stiffness of the overmold 42 to a dynamic stiffness of the substrate 40 is 2-3. In some embodiments, a material thickness of the substrate 40 is in the range of 1.5 millimeters to 3 millimeters. While the C-shaped cross-section is illustrated and described herein, in other embodiments the substrate 40 may have other cross-sectional shapes, such as a square or circular closed tubular cross-section, or a substantially flat and planar cross-sectional shape.

The C-shaped cross-section includes a substrate base 44 with two substrate arms 46 extending therefrom. The substrate arms 46 are spaced apart and in some embodiments extend parallelly to one another. In some embodiments, the substrate arms 46 have a variable or tapered arm length 48 from the first member end 36 to the second member end 38, while in other embodiments the arm length 48 may be constant. At each of the first member end 36 and the second member end 38, an insert 50 is installed to the substrate 40, for example, between the substrate arms 46. In some embodiments, the insert 50 is formed from, for example, an aluminum material. The inserts 50 may include insert openings 52 through which fasteners (not shown) are installed, to secure the cross-member 32 to the body 12. While in the illustrated embodiment the inserts 50 have an oval shape, in other embodiments other shapes may be utilized, such as circular, elliptical or rectangular. In still other embodiments, inserts are not utilized and the fasteners extend directly through the substrate 40.

Referring again to FIG. 2, the substrate 40 and the inserts 50 are encapsulated in the overmold 42, which is applied by a traditional injection-molding process. The overmold 42 is of a thermoplastic material, such as a glass-reinforced polyamide 66 (PA66) or PA6 material. The PA66 material is characterized by its strength, rigidity, and chemical resistance, as well as vibration dampening properties to mitigate noise, vibration and harshness (NVH). The overmold 42 defines an outer periphery 53 of the cross-member 32, which in some embodiments is asymmetrical as illustrated in FIG. 2.

The overmold 42 includes a body portion 54 enclosed by the outer periphery 52. In some embodiments, the outer periphery 52 has a greater material thickness than the body portion 54, or webs. One or more bushing openings 56 are formed in the body portion 54, outside of the perimeter of the substrate 40, so that the bushing openings 56 do not extend through the substrate 40. Elastomeric bushings 58 are installed in the bushing openings 56, via which a powertrain component 34 is supported by the cross-member 32. The overmold 42 includes a plurality of ribs 60, or other localized increases in material thickness to maintain a desired stiffness and vibration absorption properties of the cross-member 32. The overmold 42 has a dynamic stiffness significantly greater than the substrate 40. In some embodiments, the dynamic stiffness of the overmold 42 is in the range of 2 to 3 times the dynamic stiffness of the substrate 40. In embodiments where the cross-member 32 is supportive of an electric drive unit, the cross-member 32 may be configured such that a global vibratory first resonance mode of the cross-member 32 is less than 500 Hz. In other embodiments, the cross-member 32 could be used to support other kinds of actuated devices that can exhibit different source frequency ranges and therefore may require the crossmember to be designed to a different first resonance mode than 500 Hz.

To ensure adhesion of the overmold 42 to the substrate 40, the substrate 40 is treated via one or more of a laser treatment and a plasma treatment process prior to applying the overmold 42. The laser treatment may include, for example, laser cleaning, laser ablation, laser resurfacing, or laser restructuring. The laser treatment defines troughs in an outer surface of the substrate 40 to allow flow of the overmold 42 thereinto, thus mechanically securing the overmold 42 to the substrate 40. This improves bonding of the overmold 42 to the substrate 40, where bonding is defined herein as surface-to-surface adhesion through means other than mechanical inter-locking. In some embodiments, the laser treatment allows for the definition of a hook-and-loop structure between the substrate 40 and the overmold 42. For laser treatment, the laser parameters are set such that a heat-treated metal substrate does not significantly alter the grain structure due to thermal load from the laser treatment. Additionally or alternatively, the laser treatment parameters may be varied depending on the areas of the substrate 40 that have been work hardened and those which have not.

The laser cleaning removes contaminants from the substrate 40 so they are not present during the injection molding process of applying the overmold 42 to the substrate 40. Additionally, laser ablation may be performed to bring about a higher surface energy of the metal material of the substrate 40. Additionally or alternatively, the plasma treatment may be utilized to create a chemical bond between the substrate 40 and the overmold 42. The plasma treatment increases the surface energy and may include the creation of a thin film or coating on the substrate 40.

The configuration of cross-member 32 disclosed herein allows for improved flexibility in achieving global tuning of the cross-member 32 for stiffness, strength, and low-pass-filter effect for vibration transmissibility through choice of PA66 Polymer damping, glass fiber reinforcement content percentage, shape optimization, metal structure material choice and shape. The configurations provide a double isolation effect through intrinsic polymer damping of the overmold 42 and the attached elastomer bushings, avoiding the use of ancillary damping devices like mass dampers. The cross-member 32 is a modular configuration for electric drive unit integration into the vehicle structure allowing offline assembly. The configurations are further particularly well suited to awkward topologies where forming a metal cross-member might have manufacturing restrictions or require a more expensive hydroforming process allowing for the bushing(s) to be appropriately positioned relative to drive unit.

The terms “a” and “an” do not denote a limitation of quantity, but rather denote the presence of at least one of the referenced item. The term “or” means “and/or” unless clearly indicated otherwise by context. Any reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A structural member of a vehicle, comprising:
a metal substrate portion; and
an overmold portion of a glass fiber reinforced thermoplastic material joined to the metal substrate portion, the overmold portion connected to and supportive of one or more actuated components of the vehicle;
wherein the metal substrate portion is subjected to one or more surface treatments to ensure bonding of the overmold portion thereto.

2. The structural member of claim 1, wherein the overmold portion is configured to have a greater stiffness than the metal substrate portion.

3. The structural member of claim 1, wherein the overmold portion is formed from one of a polyamide 66 or a polyamide 6 material.

4. The structural member of claim 1, wherein the one or more surface treatments include one or more of a laser treatment and a plasma treatment of the metal substrate portion.

5. The structural member of claim 4, wherein:
the one or more surface treatments define one or more of a plurality of troughs, or a hook-and-loop structure via laser treatment of an outer surface of the metal substrate portion into which the material of the overmold portion is flowed; and
the laser treatment includes one or more of laser cleaning or laser ablation by changing surface energy, microstructure, or surface chemistry to enhance chemical bonding between the overmold portion and the metal substrate portion.

6. The structural member of claim 4, wherein one of a substrate surface energy is increased, or a thin film is created on the substrate surface via the plasma treatment to enhance chemical bonding between the overmold portion and the metal substrate portion.

7. The structural member of claim 1, wherein the overmold portion includes:
one or more bushing openings extending therethrough outside of a perimeter of the metal substrate portion; and
the one or more bushing openings are receptive of an elastomeric bushing via which the one or more actuated components are secured to the structural member.

8. A vehicle comprising:
a vehicle structure; and
a structural member extending at least partially across a width of the vehicle structure and secured to the vehicle structure, the structural member including:
a metal substrate portion; and
an overmold portion of a glass fiber reinforced plastic material joined to the metal substrate portion, the overmold portion connected to and supportive of one or more actuated devices of the vehicle; and
wherein the metal substrate portion is subjected to one or more surface treatments to ensure bonding of the overmold portion to the metal substrate portion.

9. The vehicle of claim 8, wherein the overmold portion is configured to have a greater stiffness than the metal substrate portion.

10. The vehicle of claim 8, wherein the overmold portion is formed from one of a polyamide 66 or polyamide 6 material.

11. The vehicle of claim 8, wherein the one or more surface treatments include one or more of a laser treatment and a plasma treatment of the metal substrate portion.

12. The vehicle of claim 11, wherein:
the one or more surface treatments define one or more of a plurality of troughs, or a hook-and-loop structure via laser treatment of an outer surface of the metal substrate portion into which the material of the overmold portion is flowed; and
the laser treatment includes one or more of laser cleaning or laser ablation by changing surface energy, microstructure, or surface chemistry to enhance chemical bonding between the overmold portion and the metal substrate portion.

13. The vehicle of claim 11, wherein one of a substrate surface energy is increased, or a thin film is created on the substrate surface via the plasma treatment to enhance chemical bonding between the overmold portion and the metal substrate portion.

14. The vehicle of claim 8, wherein the overmold portion includes:
one or more bushing openings extending therethrough outside of a perimeter of the metal substrate portion; and
the one or more bushing openings are receptive of an elastomeric bushing via which the one or more actuated components are secured to the structural member.

15. A method of forming a structural member of a vehicle, comprising:
forming a metal substrate portion;
applying one or more surface treatments to an outer surface of the metal substrate portion; and
applying an overmold portion over the metal substrate portion;
wherein the overmold portion is formed from a glass fiber reinforced plastic material; and
wherein the overmold portion is configured to be connected to and support one or more actuated components of the vehicle.

16. The method of claim 15, wherein the one or more surface treatments include one or more of a laser treatment and a plasma treatment of the metal substrate portion.

17. The method of claim 16, wherein:
the one or more surface treatments define one or more of a plurality of troughs, or a hook-and-loop structure via laser treatment of an outer surface of the metal substrate portion into which the overmold portion is flowed; and
the laser treatment includes one or more of laser cleaning or laser ablation by changing surface energy, microstructure, or surface chemistry to enhance chemical bonding between the overmold portion and the metal substrate portion.

18. The method of claim 16, wherein one of a substrate surface energy is increased, or a thin film is created on the substrate surface via the plasma treatment to enhance chemical bonding between the overmold portion and the metal substrate portion.

19. The method of claim 15, wherein the overmold portion is configured to have a greater stiffness than the metal substrate portion.

20. The method of claim 15, wherein the overmold portion is formed via injection molding.
